(19) United States
(12) Patent Application Publication
(10) Pub. No.: US 2013/0148267 A1
(43) Pub. Date: Jun. 13, 2013

(54) SEALING MEMBER AND CAPACITOR USING SAME

(71) Applicants: Norihisa Takahara, Osaka (JP); Hideki Shimamoto, Kyoto (JP); Kiyoshi Hirota, Osaka (JP); Yuichiro Tsubaki, Kyoto (JP)

(72) Inventors: Norihisa Takahara, Osaka (JP); Hideki Shimamoto, Kyoto (JP); Kiyoshi Hirota, Osaka (JP); Yuichiro Tsubaki, Kyoto (JP)

(73) Assignee: PANASONIC CORPORATION, Osaka (JP)

(21) Appl. No.: 13/818,020

(22) PCT Filed: Sep. 8, 2011
(86) PCT No.: PCT/JP2011/005041

§ 371 Date: Feb. 20, 2013

(30) Foreign Application Priority Data
Sep. 22, 2010 (JP) 2010-211773

(51) Int. Cl. H01G 2/10

(52) U.S. Cl. CPC H01G 2/103
USPC 361/518; 277/628

(57) ABSTRACT

A capacitor having an electrolyte solution, in which a sealing member has a gas barrier layer provided with lead holes and through holes, and a rubber material sandwiching the gas barrier layer. The gas barrier layer includes a material having lower gas permeability than the rubber material. The through holes are filled with the rubber material.

### TECHNICAL FIELD

The present invention relates to a capacitor used in various electronic equipment, electric equipment, industrial equipment, automotive equipment, and the like, and, in particular, to a capacitor using an electrolyte solution and a sealing member used for the same.

### BACKGROUND ART

FIG. 10 is a sectional view of a conventional aluminum electrolytic capacitor. Capacitor element 2 is impregnated with an electrolyte solution and then housed in metal case 3. A pair of lead terminals 4 and 5 led out from capacitor element 2 penetrates through lead holes 7 of sealing member 6A disposed at an opening part of metal case 3 and are led out to the outside. Furthermore, sealing member 6A is pressed by drawing processing with respect to a vicinity of the opening part and curling processing with respect to an opening end of metal case 3 so as to seal the opening part of metal case 3.

In conventional aluminum electrolytic capacitor 1A, as sealing member 6A, rubber material 8 made of butyl rubber having low gas permeability is generally used. When sealing is carried out with a material having low gas permeability, even if a solvent component of the electrolyte solution is vaporized, it does not easily permeate through sealing member 6A. Thus, deterioration of electrical characteristics of the capacitor can be suppressed.

However, even when butyl rubber is used, a solvent gas generated in metal case 3 permeates and is released to the outside (in the air) at a predetermined rate. Therefore, during long-time use in a high-temperature environment, dry-up occurs. The dry-up denotes a phenomenon that a solvent of an electrolyte solution vaporizes.

FIG. 11 is a sectional view of another conventional aluminum electrolytic capacitor. Recently, in order to enhance the long-term reliability at high temperatures, as shown in FIG. 11, a configuration has been considered, in which film 9 made of fluorocarbon resin having lower gas permeability than rubber material 8 is sandwiched in the center in the thickness direction of rubber material 8 so as to enhance sealing performance.

In conventional aluminum electrolytic capacitor 1B, however, adhesion between film 9 and rubber material 8 is low. Consequently, film 9 is peeled off from rubber material 8, so that a sufficient repulsion stress is not generated in sealing member 6B. As a result, sealing performance may be lowered even when film 9 is used.

That is to say, film 9 is peeled off from rubber material 8 due to an external stress generated when metal case 3 is subjected to drawing processing from the outer periphery of sealing member 6B or when lead terminals 4 and 5 are inserted, and a space is formed. This reduces the repulsion stress generated in sealing member 6B, thus forming a space between metal case 3 and sealing member 6B or between lead terminals 4 and 5 and sealing member 6B. Then, an electrolyte solution easily evaporates from the space, and thus sealing performance is deteriorated.

For prior art literatures regarding the present invention, the following Patent Literatures 1 and 2 are known.

### PATENT LITERATURE

PTL 1: Japanese Utility Model Application Unexamined Publication No. H7-3129

PTL 2: Japanese Patent Application Unexamined Publication No. H2-18922

### SUMMARY OF THE INVENTION

A sealing member of the present invention includes a gas barrier layer provided with lead holes and through holes, and a rubber material sandwiching the gas barrier layer. The gas barrier layer includes a material having lower gas permeability than the rubber material. The through holes are filled with the rubber material.

This can enhance adhesion between the gas barrier layer and the rubber material, and suppress peeling. Therefore, the sealing performance of the capacitor can be enhanced.

### BRIEF DESCRIPTION OF DRAWINGS

FIG. 1 is a sectional view of a capacitor in accordance with a first exemplary embodiment of the present invention.

FIG. 2A is a top schematic view of a sealing member in accordance with the first exemplary embodiment of the present invention.

FIG. 2B is a sectional view taken along line 2B-2B in FIG. 2A.

FIG. 2C is a sectional view taken along line 2C-2C in FIG. 2A.

FIG. 3 is a top view of a resin film used for a gas barrier layer of the sealing member in accordance with the first exemplary embodiment of the present invention.

FIG. 4A is a sectional schematic view showing a manufacturing process of the sealing member in accordance with the first exemplary embodiment of the present invention.

FIG. 4B is a sectional schematic view showing a primary cross-linking state of a rubber material in accordance with the first exemplary embodiment of the present invention.

FIG. 4C is a sectional schematic view showing a secondary cross-linking state of the rubber material in accordance with the first exemplary embodiment of the present invention.

FIG. 5 is a top schematic view of the sealing member in the manufacturing process in accordance with the first exemplary embodiment of the present invention.

FIG. 6 is a characteristic graph showing a gas permeation amount of the sealing member in accordance with the first exemplary embodiment of the present invention.

FIG. 7A is a top schematic view of a sealing member in accordance with a second exemplary embodiment of the present invention.

FIG. 7B is a sectional view taken along line 7B-7B in FIG. 7A.

FIG. 7C is a sectional view taken along line 7C-7C in FIG. 7A.

FIG. 8 is a top view of a resin film used for a gas barrier layer of the sealing member in accordance with the second exemplary embodiment of the present invention.

FIG. 9 is a sectional view of a capacitor in accordance with a third exemplary embodiment of the present invention.

FIG. 10 is a sectional view of a conventional aluminum electrolytic capacitor.

FIG. 11 is a sectional view of another conventional aluminum electrolytic capacitor.

### DESCRIPTION OF EMBODIMENTS

Hereinafter, exemplary embodiments of the present invention are described with reference to drawings. The same reference numerals are given to the same components as conventional components.

### First Exemplary Embodiment

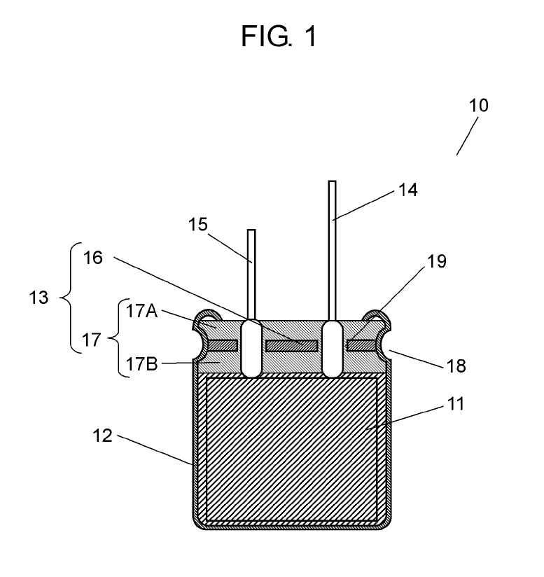

FIG. 1 is a sectional view of a capacitor in accordance with a first exemplary embodiment of the present invention. Electrolytic capacitor 10 includes capacitor element 11 obtained by winding a pair of positive and negative electrode foils via a separator, an electrolyte solution with which capacitor element 11 is impregnated, bottomed cylindrical case 12 housing capacitor element 11 and the electrolyte solution, and sealing member 13 for sealing an opening part of case 12.

Case 12 is made of metal such as aluminum and stainless steel. Case 12 has a cylindrical shape having a diameter of 10 mm and a height of 10 mm. A thickness of sealing member 13 is about 2 mm.

The electrolyte solution can use a solvent such as water, ethylene glycol and y-butyrolactone, and an electrolyte such as boric acid, adipic acid and phthalic acid.

The positive and negative electrode foils are connected to lead terminals 14 and 15, respectively. Lead terminals 14 and 15 penetrate through sealing member 13 and are led out to the outside, respectively.

Sealing member 13 includes rubber material 17 sandwiching gas barrier layer 16 in the middle in the thickness direction. That is to say, sealing member 13 includes gas barrier layer 16 provided with through holes 19 and lead holes 20, and rubber material 17 sandwiching gas barrier layer 16. Gas barrier layer 16 includes a material having lower gas permeability than of rubber material 17. Through holes 19 are filled with rubber material 17. Two lead holes 20 are formed. Each of lead terminals 14 and 15 is inserted into each of lead holes 20. Lead terminals 14 and 15 are not inserted into through holes 19.

Sealing member 13 is disposed at the opening part of case 12, and then the outer periphery of case 12 is subjected to drawing processing to the inside, so that protruding portion 18 protruding to the inside is formed. An opening end of case 12 is subjected to curling processing, so that capacitor element 11 is sealed in case 12. In this exemplary embodiment, gas barrier layer 16 is disposed in the center of sealing member 13 horizontally with respect to the opening part of case 12.

Gas barrier layer 16 of this exemplary embodiment includes a resin film such as a polyphenylene sulfide film and a polyethylene naphthalate film, and its thickness is not less than 0.02 mm and not more than 0.2 mm. As gas barrier layer 16, in addition to the resin film, an evaporation film such as an aluminum evaporation film or a silica evaporation film, and a metal film made of an aluminum foil, a copper foil, or the like, may be used. Furthermore, examples of rubber material 17 include butyl rubber, silicone rubber, fluororubber, ethylene propylene rubber, nitrile rubber, and the like. Since gas barrier layer 16 including resin and metal is less easily elastically deformed than rubber, its thickness is preferably not more than 30% of the total thickness of sealing member 13. Furthermore, a diameter of gas barrier layer 16 is substantially equal to a diameter of rubber material 17.

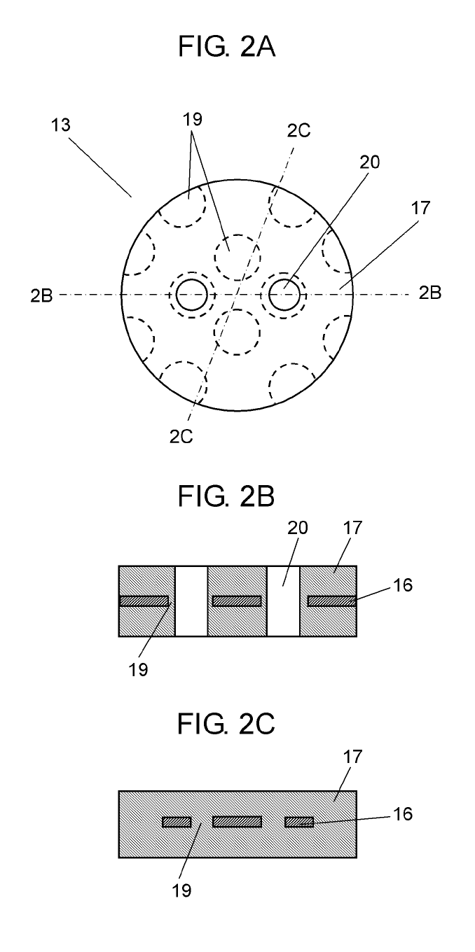

FIG. 2A is a top schematic view of sealing member 13. FIG. 2B is a sectional view taken along line 2B-2B in FIG. 2A. FIG. 2C is a sectional view taken along line 2C-2C in FIG. 2A.

Gas barrier layer 16 is provided with a plurality of through holes 19 and two lead holes 20. Through holes 19 and lead holes penetrate through gas barrier layer 16 in the thickness direction. The shape and size of through hole 19 are not limited to those of this exemplary embodiment. However, when a total area of the opening parts of through holes 19 is too large, an effect of suppressing permeation of gas mentioned below is insufficient. Therefore, it is preferable that the size and the number of through holes 19 are set such that an area of the horizontal cross-section of gas barrier layer 16 (excluding areas of through holes 19 and lead holes 20) is 50% or more of an area of the horizontal cross-section of rubber material 17. This is preferable because gas barrier layer 16 needs some degree of area in order to suppress the permeation of gas.

As shown in FIG. 2B, the inner wall of each of two lead holes 20 is covered with rubber material 17, and the inside thereof is a hollow. The hollow is also formed in rubber material 17.

Lead terminals 14 and 15 shown in FIG. 1 pass through lead holes 20, penetrate through sealing member 13, and are led out to the outside. Since the inner walls of lead holes 20 are covered with rubber material 17, in lead holes 20, the entire outer peripheries of lead terminals 14 and 15 are covered with rubber material 17. Thus, stress loading from lead terminals 14 and 15 is absorbed by rubber material 17, gas barrier layer 16 in the vicinity of lead terminals 14 and 15 is not easily peeled off.

Also as shown in FIG. 2C, rubber material 17 is filled in through holes 19 into which lead terminals 14 and 15 are not inserted.

Furthermore, through hole 19 may be formed in the outer periphery of gas barrier layer 16. In this case, even when the diameter of gas barrier layer 16 and the diameter of rubber material 17 are the same as each other, through hole 19 formed in the outer periphery of gas barrier layer 16 is covered with rubber material 17. Consequently, a part of the outer periphery of gas barrier layer 16 is filled with rubber material 17. In this way, when at least a part of the outer periphery of gas barrier layer 16 is filled with rubber material 17, upper rubber material 17A and lower rubber material 17B are cross-linked inside through hole 19 also in the outer periphery, and gas barrier layer 16 is not easily peeled off from rubber material 17.

Note here that rubber material 17 covers not less than 50% and less than 100% of the outer periphery of gas barrier layer 16. Thus, even if an external stress from a side surface of case 12 is applied, peeling of gas barrier layer 16 can be suppressed.

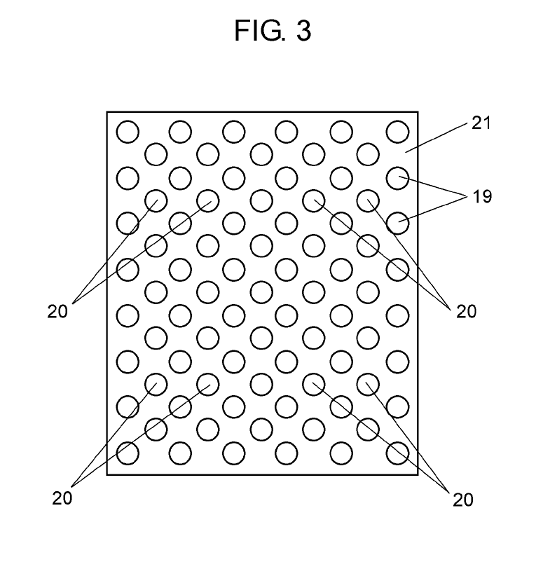

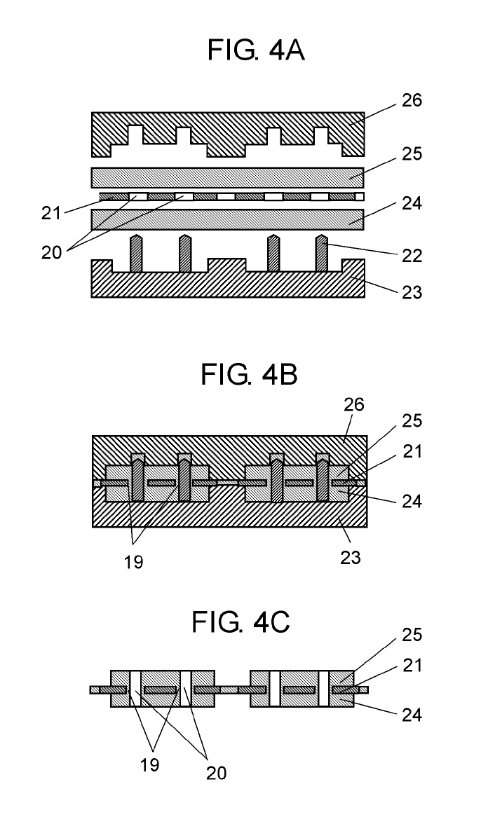

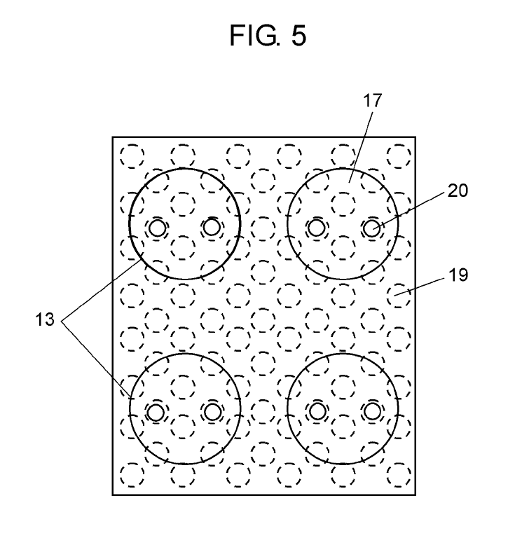

Hereinafter, a method of manufacturing sealing member 13 in this exemplary embodiment is described. FIG. 3 is a top view of the resin film used for the gas barrier layer of the sealing member in accordance with the first exemplary embodiment of the present invention. FIG. 4A is a sectional schematic view showing a manufacturing process of the sealing member in accordance with the first exemplary embodiment of the present invention. FIG. 4B is a sectional schematic view showing a primary cross-linking state of the rubber material in accordance with the first exemplary embodiment of the present invention. FIG. 4C is a sectional schematic view showing a secondary cross-linking state of the rubber material in accordance with the first exemplary embodiment of the present invention. FIG. 5 is a top schematic view of the sealing member in the manufacturing process in accordance with the first exemplary embodiment of the present invention.

Firstly, as shown in FIG. 3, through holes 19 and lead holes 20 are formed in resin film 21 or a metal film that is to be gas barrier layer 16 by punching or molding with a mold.

Next, as shown in FIG. 4A, uncross-linked lower rubber sheet 24 to be formed into lower rubber material 17B, resin film 21 to be formed into gas barrier layer 16, and uncross-linked upper rubber sheet 25 to be formed into rubber material 17A are sequentially laminated on lower mold 23 provided with pins 22 in positions into which lead terminals 14 and 15 are inserted. At this time, they are placed in such a manner that pins 22 pass through the inside of lead holes 20 of resin film 21.

Thereafter, as shown in FIG. 4B, lower mold 23 and upper mold 26 are heated together, thus allowing upper rubber sheet 25 and lower rubber sheet 24 to be cross-linked to each other (primary cross-linking). Upper rubber sheet 25 and lower rubber sheet 24 enter also the inside of through holes 19, respectively, so that they are linked to each other via through holes 19.

As shown in FIG. 4C, lower mold 23 and upper mold 26 are removed, and heating is carried out again so as to cross-link upper rubber sheet 25 and lower rubber sheet 24 to each other (secondary cross-linking). Thus, upper rubber sheet 25 and lower rubber sheet 24 are chemically bonded strongly and integrated with each other inside through holes 19 of resin film 21. Therefore, adhesion of resin film 21 with respect to upper rubber sheet 25 and lower rubber sheet 24, that is, adhesion of gas barrier layer 16 of sealing member 13 with respect to upper rubber material 17A and lower rubber material 17B shown in FIG. 1 is enhanced.

In the above-mentioned processes, as shown in FIG. 5, a plurality of sealing members 13 are molded at one time. This is punched into individual pieces to obtain sealing member 13.

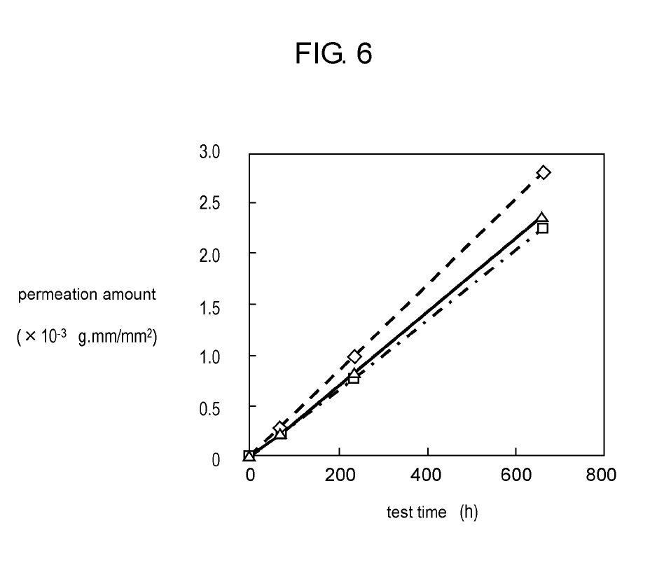

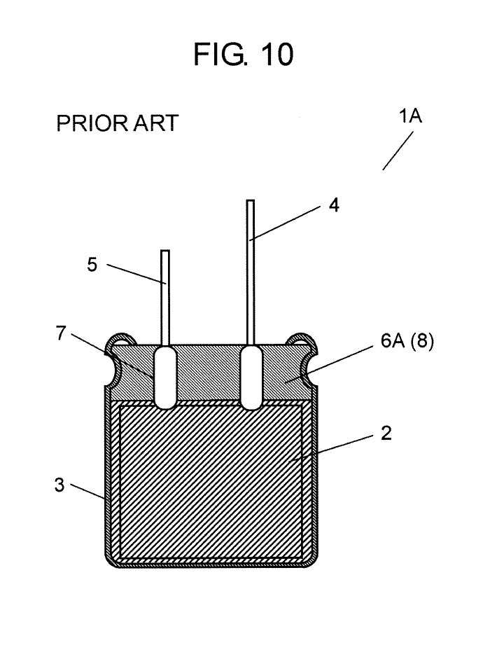

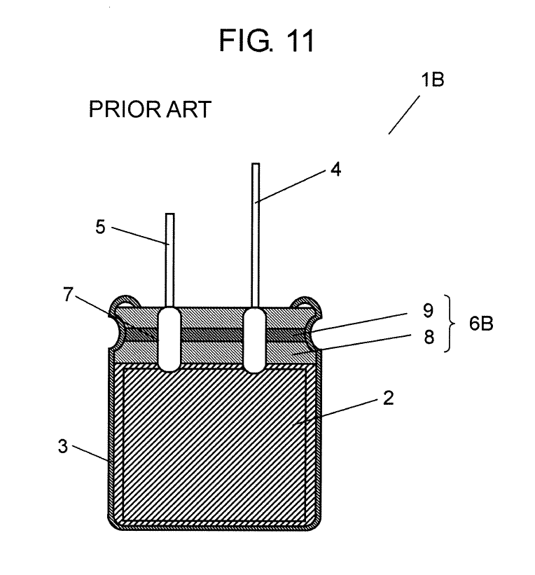

FIG. 6 is a characteristic graph showing a gas permeation amount of the sealing member in accordance with the first exemplary embodiment of the present invention. FIG. 6 shows relation between the gas permeation amount and the time in sealing member 13 of this exemplary embodiment and a conventional sealing member. As a conventional example, sealing member 6A including only rubber material 8 without including gas barrier layer 16 is used as shown in FIG. 10 as Comparative Example 1, and a sealing member sandwiching film 9 as a gas barrier layer without including through hole 19 is used as shown in FIG. 11 as Comparative Example 2. In FIG. 6, a property of this exemplary embodiment is shown by a solid line, a property of Comparative Example 1 is shown by a broken line, and a property of Comparative Example 2 is shown by an alternate long and short dash line.

The gas permeation amount is calculated from a reduction amount of the electrolyte solution (whose solvent is y-butyrolactone) with the passage of time when the capacitor using each sealing member is placed in a high-temperature bath at 135° C. As shown in FIG. 6, this exemplary embodiment and Comparative Example 2 including gas barrier layer 16 can reduce the gas permeation amount as compared with Comparative Example 1 which does not include gas barrier layer 16. Note here that in this case, one sample each is used.

Next, by using the sealing members according to this exemplary embodiment and Comparative Example 2, a peeling test of the gas barrier layer is carried out. In the peeling test, each sealing member is soaked in y-butyrolactone and stood still at 135° C. for 24 hours, and thereafter the interface between the gas barrier layer and the rubber material is observed. As a result, in Comparative Example 2, peeling occurs in four out of five samples, but in this exemplary embodiment, peeling occurs none of five samples. Therefore, in sealing member 13 of this exemplary embodiment, the gas permeation amount is low, and peeling of gas barrier layer 16 does not easily occur.

In a sample of Comparative Example 2 in which peeling occurs, the gas permeation amount in FIG. 6 is also increased. That is to say, in Comparative Example 2, when peeling does not occur, the gas permeation amount can be reduced, but variation is large because adhesion between film 9 and rubber material 8 is low. Therefore, there is a high possibility that peeling occurs, and when the peeling occurs, the gas permeation amount is increased.

When gas barrier layer 16 is peeled off from rubber material 17, a space is generated due to the reduction of a repulsion stress, and an electrolyte solution is easily evaporated from this space, thus deteriorating sealing performance. In this exemplary embodiment, by providing through holes 19 in gas barrier layer 16, upper rubber material 17A and lower rubber material 17B are cross-linked to each other in through hole 19, and thus peeling between gas barrier layer 16 and rubber material 17 can be suppressed. Therefore, dry-up of the electrolyte solution can be suppressed, and capacitor 10 has high reliability for the long time also in the case where it is used at high temperature conditions.

Furthermore, in this exemplary embodiment, since the outer peripheries of lead terminals 14 and 15 are covered with rubber material 17, it is possible to reduce stress loading to gas barrier layer 16 at the time when lead terminals 14 and 15 are inserted. Consequently, peeling between gas barrier layer 16 and rubber material 17 in the vicinity of lead terminals 14 and 15 can be suppressed. Therefore, leakage of the electrolyte solution flowing along lead terminals 14 and 15 can be suppressed, and thus high reliability can be achieved.

### Second Exemplary Embodiment

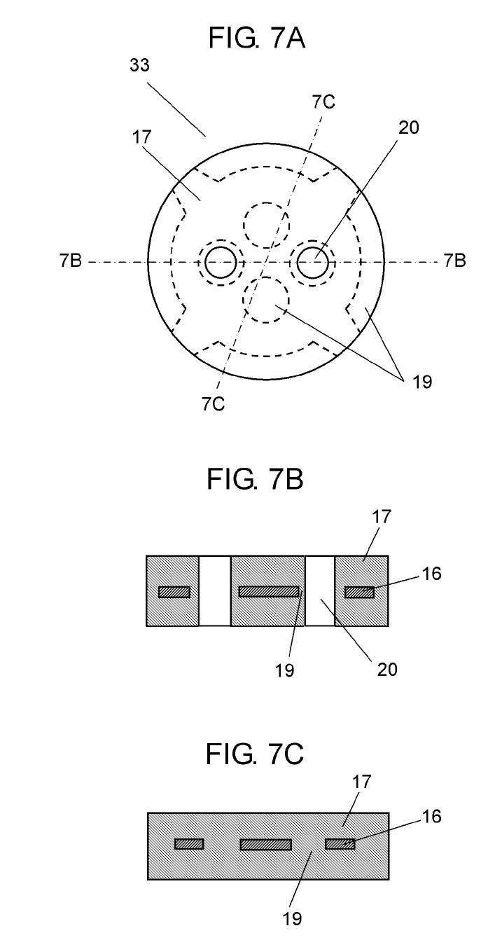

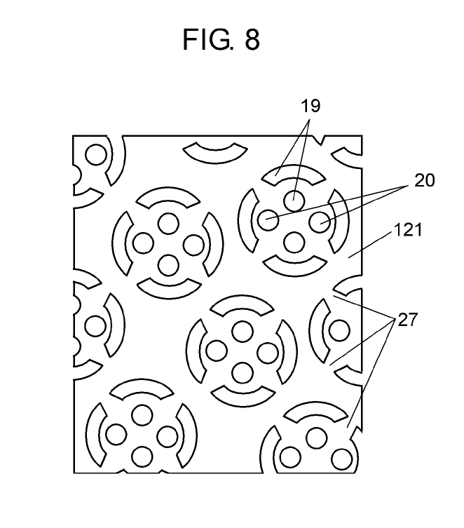

FIG. 7A is a top schematic view of a sealing member in accordance with a second exemplary embodiment of the present invention. FIG. 7B is a sectional view taken along line 7B-7B in FIG. 7A. FIG. 7C is a sectional view taken along line 7C-7C in FIG. 7A. FIG. 8 is a top view of a resin film used for a gas barrier layer of the sealing member in accordance with the second exemplary embodiment of the present invention.

A main difference between this exemplary embodiment and the first exemplary embodiment is in a configuration of through hole 19 shown in FIG. 7A. Other configurations and effects that are the same as those in the first exemplary embodiment are omitted. That is to say, in this exemplary embodiment, sealing member 33 is used instead of sealing member 13 of capacitor 10 in FIG. 1. Sealing member 13 and sealing member 33 are different from each other in the configuration of through hole 19 of gas barrier layer 16.

In sealing member 33, the shape and position of through holes 19 are designed in such a manner that 75% or more of the outer periphery of gas barrier layer 16 is covered with rubber material 17. Thus, also in any of cross-sections of FIGS. 7B and 7C, the outer periphery of gas barrier layer 16 is covered with rubber material 17.

In order to cover the entire outer periphery of gas barrier layer 16 with rubber material 17, it is necessary to use gas barrier layer 16 having a smaller diameter than that of rubber material 17 and to insert gas barrier layer 16 that is divided into an individual piece into each sealing member 33. Thus, productivity is reduced. Consequently, in this exemplary embodiment, for covering the outer periphery of the side surface of gas barrier layer 16 with rubber material 17 over the side surface as wide as possible and forming a plurality of sealing members 33 at one time, resin film 121 provided with through holes 19 as shown in FIG. 8 is used. Resin film 121 has a shape in which a part thereof is allowed to remain as linking crosspiece 27 and individual gas barrier layers 16 are integrated with each other.

In this exemplary embodiment, by using resin film 121 mentioned above, each sealing member 33 has a configuration in which the outer periphery other than linking crosspiece 27 of gas barrier layer 16 includes a rubber material. With such a configuration, the peeling of sealing member 33 in the outer periphery can be further suppressed.

In this exemplary embodiment, 75% or more of the outer periphery of gas barrier layer 16 is covered with rubber material 17. However, when at least 50% or more of the outer periphery is covered, even if an external stress, for example, drawing processing, from the side surface of case 12 is applied, it is possible to suppress the peeling of gas barrier layer 16.

### Third Exemplary Embodiment

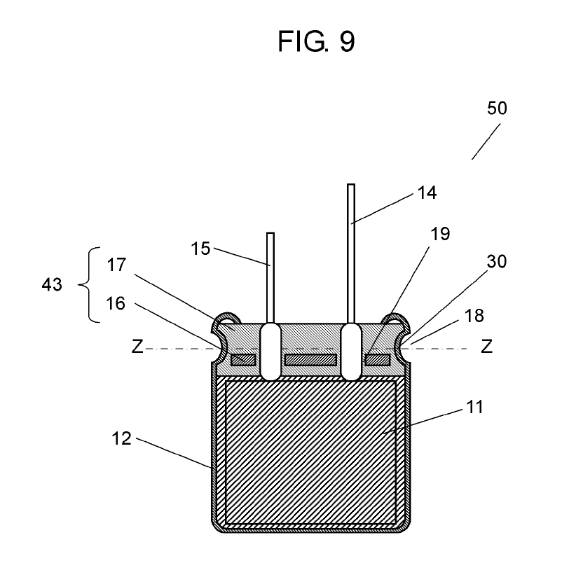

FIG. 9 is a sectional view of capacitor 50 in accordance with a third exemplary embodiment of the present invention. A main difference between this exemplary embodiment and the first exemplary embodiment is in the position of gas barrier layer 16. In the first exemplary embodiment, gas barrier layer 16 is disposed in the center in the thickness direction of sealing member 13. Meanwhile, in sealing member 43, gas barrier layer 16 is disposed in such a manner that it is displaced in the lower side (capacitor element 11 side) from the center (line Z-Z) in the thickness direction. That is to say, the outer peripheral end of gas barrier layer 16 is disposed such that it deviates from the center in the thickness direction of sealing member 43, and such that a plane including innermost section 30 of protruding portion 18 and a plane linking the outer peripheral end of gas barrier layer 16 deviate from each other.

In sealing member 43, a stress is likely concentrated on a portion that is brought into contact with innermost section 30 of a portion (protruding portion 18) protruded by drawing processing of case 12. Therefore, when an outer peripheral end of gas barrier layer 16 is located on the same plane as that of innermost section 30 of protruding portion 18, gas barrier layer 16 undergoes a large stress from the side part, so that peeling occurs easily. Since innermost section 30 of protruding portion 18 is brought into close contact with the center in the thickness direction of sealing member 43 in many cases, by allowing the position of gas barrier layer 16 to deviate from the center in the thickness direction of sealing member 43, peeling of gas barrier layer 16 can be suppressed. In this exemplary embodiment, gas barrier layer 16 is displaced in the lower side from the center portion, but it may be displaced in the upper side. Furthermore, only the outer peripheral end of gas barrier layer 16 is curved or bent downward or upward, so that it may not be provided in the same plane as that of innermost section 30 of protruding portion 18. When at least outer peripheral end is allowed to deviate from innermost section 30 of protruding portion 18, peeling can be suppressed.

Note here that when innermost section 30 of protruding portion 18 is not brought into close contact with the center of sealing member 43, the position of gas barrier layer 16 only needs to be allowed to deviate upward or downward from innermost section 30 of protruding portion 18 such that innermost section 30 of protruding portion 18 and gas barrier layer 16 are not brought into contact with each other.

In the above-mentioned first to third exemplary embodiments, electrolytic capacitors 10 and 50 are employed as an example of a capacitor, but the embodiments can be applied to a capacitor such as an electric double layer capacitor.

Furthermore, in the above-mentioned first to third exemplary embodiments, only one gas barrier layer is provided, but a plurality of gas barrier layers may be provided.

### INDUSTRIAL APPLICABILITY

In a capacitor according to the present invention, dry-up can be suppressed by enhancing sealing performance by a sealing member.

Therefore, the capacitor is useful as a capacitor that is required to be used in a high-temperature environment.

### REFERENCE MARKS IN DRAWINGS

10, 50 electrolytic capacitor

11 capacitor element

12 case

13, 33, 43 sealing member

14, 15 lead terminal

16 gas barrier layer

17 rubber material

17A upper rubber material

17B lower rubber material

18 protruding portion

19 through hole

20 lead hole

21, 121 resin film

22 pin

23 lower mold

24 lower rubber sheet

25 upper rubber sheet

26 upper mold

27 linking crosspiece

30 innermost section

1. A sealing member comprising:
a gas barrier layer provided with two lead holes and a plurality of through holes other than the two lead holes; and
a rubber material sandwiching the gas barrier layer;
wherein the gas barrier layer includes a material having lower gas permeability than the rubber material; and
the through holes are filled with the rubber material.

2. The sealing member of claim 1,
wherein 50% or more of an outer periphery of the gas barrier layer is covered with the rubber material.

3. The sealing member of claim 1,
wherein an area of a horizontal cross-section of the gas barrier layer excluding the lead holes and the through holes is 50% or more of an area of a horizontal cross-section of the rubber material.

4. The sealing member of claim 1,
wherein an outer peripheral end of the gas barrier layer is disposed such that it deviates from a center in a thickness direction of the sealing member.

5. The sealing member of claim 1,
wherein the rubber material is cross-linked inside each of the through holes.

6. The sealing member of claim 1,
wherein each one of the lead holes penetrates through the rubber material, and an inner wall of the lead hole is covered with the rubber material.

7. A capacitor comprising:
a capacitor element;
an electrolyte solution with which the capacitor element is impregnated;
a bottomed cylindrical case housing the capacitor element and the electrolyte solution; and
a sealing member for sealing an opening part of the case, which includes
a gas barrier layer provided with two lead holes and a plurality of through holes other than the two lead holes, and
a rubber material sandwiching the gas barrier layer,
wherein the gas barrier layer includes a material having lower gas permeability than the rubber material, and
the through holes are filled with the rubber material.

8. The capacitor of claim 7,
wherein the case has a protruding portion protruding to an inside thereof,
a plane including an innermost section of the protruding portion, and a plane linking outer peripheral end of the gas barrier layer are disposed such that they deviate from each other.

9. The capacitor of claim 7, further comprising lead terminals each connected to each of a pair of positive and negative electrode foils,
wherein each one of the lead terminals passes through one of the two lead holes, penetrates through the sealing member, and is led outside, and
an outer periphery of the lead terminal is covered with the rubber material in the one of the two lead holes.
